(19) United States
(12) Patent Application Publication
(10) Pub. No.: US 2013/0041847 A1
(43) Pub. Date: Feb. 14, 2013

(54) Apparatus For Displaying Orders For Financial Derivatives And Evaluating Financial Derivatives, And A System And A Method Thereof

(71) Applicant: Kevin Kiu Tsun MAK, Sheung Wan (HK)

(72) Inventor: Kevin Kiu Tsun MAK, Sheung Wan (HK)

(21) Appl. No.: 13/654,547

(22) Filed: Oct. 18, 2012

Related U.S. Application Data
(63) Continuation of application No. 13/099,642, filed on May 3, 2011.

(30) Foreign Application Priority Data
May 14, 2010 (HK) 10104692.1

(51) Int. Cl. G06Q 40/00

(52) U.S. Cl. 705/36 R

(57) ABSTRACT

A computer screen showing a computer generated bar chart representing orders for financial derivatives, wherein the bid and offer prices for the orders are represented by markers in the bar chart. The volatility of the derivatives is calculated and represented by a volatility line in the chart. The extent to which the bids and offers differ from the theoretical value is represented by the distance between the markers and the volatility line.

### RELATED APPLICATIONS

This application is a continuation of U.S. patent application Ser. No. 13/099,642, filed May 3, 2011 which claimed priority in Hong Kong patent application no. 10104692.1, filed May 14, 2010, the contents of which are hereby incorporated by reference.

### FIELD OF INVENTION

This invention relates to an apparatus, a system and a method for evaluating financial derivative instruments, such as warrants, futures and options.

### BACKGROUND OF THE INVENTION

An option is a commonly used financial derivative instrument which, instead of trading on a specific underlying asset such as a commodity or equity, a trader trades on an option to buy (bid) or sell (offer) the asset (known as the underlier of the option) by a certain date (known as the exercise date or the expiry date) and at a pre-determined price (known as the strike price).

Depending on whether an option gives the trader a right to sell the underlying asset, or to buy the under lying asset, the option may be a ‘call option’ or a ‘put option’. More specifically,
buying a ‘call option’ gives the trader the right but not the obligation to buy the underlier at the strike price.
buying a ‘put option’ gives the trader the right but not the obligation to sell the underlier at the strike price.

When an option expires, the trader does not recover the money he paid in buying the option.

Like the underlier, options may be traded between traders and their prices vary according to market forces. When a trader wishes to sell an option, he raises an order called an ‘offer’. The same terminology applies whether the option is a call option or a put option. When a trader wishes to buy an option, he raises an order called a ‘bid’.

If an option trader believes that the price of the underlier will be at or above $x on the exercise date he can choose to purchase a call option with a strike price below $x, and the difference between the strike price and $x becomes his profit, less the cost of buying the option. This can be achieved by exercising the option and obtaining the underlier at a lower than market price, or by settling the difference in a cash transaction with the counterparty. Similarly, the trader can purchase a put option with a strike price above $x if he believes the underlier will be at or below $x. In this way, if the actual price of the underlier is indeed $x, the trader is able to profit on the difference between the strike price and the market price less the cost of the option by either exercising the option, or settling the difference.

Options are not exercised if exercising the option is not financially favourable. For example, when the strike price of a put option is below the market price of the underlier at the exercise date, or if the strike price of a call option is above the market price of the underlier at the exercise date. Furthermore, even if the option strike price is favourable against the market price of the underlier, the option trader may still choose not to exercise the option if he would incur a loss by doing so. That is, the gains which the trader makes by buying an option can be cancelled out by the higher price he has to pay to exercise it.

Many devices and technologies have been proposed to value an option in view of the option's market value, to guide option traders in placing their bids and offers. For example, U.S. Pat. No. 6,993,504 discloses a system for indicating whether the premium of an option is a worthwhile investment. The method of U.S. Pat. No. 699504 is to use bars in a chart to indicate visually the difference between the lowest offer price and the highest bid price. The quantity of each offer is indicated by the size of the bar, as the bar's length or height. However, the method of U.S. Pat. No. 6,993,504 does not provide enough information for guiding the user to tell the trader whether an option is overpriced or under priced relative to other similar options.

Typically, each option has a theoretical value which can be calculated based on the strike price, the expiry date, the volatility of the option and so on. There are several formulae proposed by academics for calculating the theoretical value. While these formulae are useful in telling the trader if an option is over priced or under priced, the calculations required are too difficult for option traders to repeat for each and every option. Given the high intensity of trading, it is not possible for a trader to make his calculations speedily enough during a trading session, even if he uses a spreadsheet to work out the calculations. Furthermore, the calculated theoretical value and other information such as the actual price, an often rapidly varying current value of the underlying, the expiry date and the volatility of the options are just too many numbers for a trader to effectively and continually keep track of.

Therefore, it is desirable to provide a system, an apparatus and/or method for which could improve the trader's understanding of the options market.

### SUMMARY OF THE INVENTION

In a first aspect, the invention proposes a computer based system suitable for displaying orders for financial derivatives such as options, comprising a memory for receiving and storing data related to orders for each option in a plurality of options for an underlying asset; a processor using the order data for calculating a theoretical value and the volatility of each of the plurality of options; a screen for displaying the orders for the options, the orders being in the form of bids and offers for each of the options, the options having the same exercise date; the processor using the order data to generate an output to the screen for displaying a chart having a horizontal axis representing options according to their strike price, and a vertical axis representing the volatility; each one of the bids and offers being represented by a marker, the processor calculating a volatility for each option for display on the chart as a volatility line 201 indicating the calculated volatility of the options; wherein the markers are placed such that the distance between each marker from the volatility line 201 indicates the extent that the price of the bid or offer for an option represented by the marker differs from the theoretical value of the option.

Advantageously, the invention provides the possibility that the trader is able to tell at a glance from the chart where the highest bid for an option or the lowest offer for an option is close to the theoretical value of the option. If the value of the lowest offer is near enough to the theoretical value, the trader can decide to place a bid to match the lowest offer to buy an option. Conversely, if the value of the highest bid is near enough to the theoretical value, the trader can decide to place an offer to match the highest bid to sell an option. As the chart represents a technologically enabled presentation, the information displayed may be refreshed in real time using updated data based on market transactions as they occur. The traders are thereby able to react with speed based on accurate information.

Preferably, the volatility line 201 is movable along the vertical axis from a first position to a second position; such that the theoretical values of the options are re-calculated according to the second position of the volatility line 201; and the markers are re-positioned to reflect the difference between the bids and offers from the re-calculated theoretical value. Furthermore, it is preferable that one or more points along the volatility line 201 can be fixed by the user such that the fixed points are not movable when the other points of the volatility line 201 are adjusted along the vertical axis.

Therefore, the invention provides the possibility that the trader can adjust the volatility line 201 according to his own valuation parameters to re-evaluate the existing orders. An offer which would be deemed too high at first can become attractive if the trader moved the volatility line 201 upwards, such that the lowest option offer is now either at or below the theoretical value. This is possible based on the trader's personal view of the options market, i.e. the market is undervalued, which he reflects by moving the volatility curve to a position he thinks is more suitable. At the same time, as all the options of different strike prices but having the same exercise date are shown along with the volatility line 201, the trader can make an intelligent guess as to which are the more worthwhile purchases among the options of different strike prices. The same applies to selling options. This method of graphical and relative valuation can be extended to evaluate options of different exercise dates, such as by implementation of a 3 dimensional graph of the volatility surface, with the added axis being a scale for the exercise date. Advantageously, this provides yet further flexibility to the user in adjusting the volatility line 201. Thus the user is able to “price to the market” and ascertain parameters to the model accordingly as a method of backwards induction.

Preferably, the volatility line 201 has a thickness which is adjusted by the processor to be indicative of the cost of transaction for each of the options. Advantageously, the trader can tell at a glance if the transaction costs such as administrative fees, brokerage fees, and/or costs of hedging add significantly to the cost of the purchase or sale of the option, with the transaction cost data collected, stored in memory and made available to the processor for generating a line thickness on the display corresponding thereto. This further aids the trader to make transaction decisions quickly.

Preferably, the markers representing the offers for each option are grouped into a top bar in the chart; and the markers representing the bids for the option are grouped into a bottom bar in the chart.

Preferably, each option has a delta value which is also generated and displayed in the chart. The delta is an indication of the probability of the underlier reaching the strike price of the option. The bars of markers representing options of different strike prices are spaced apart from each other along the horizontal axis in the chart in proportion to their delta. Advantageously, the trader can tell at a glance from the delta value if the option is likely to close in favour of the strike price. That is, if the underlier will be above the strike price at the exercise date of the option, which is favourable to the call option or if the underlier will be below the strike price at the exercise date of the option, which is favourable to the put option. The trader is also able to tell at a glance how similar in attributes an option is compared with another option from the distance they are apart in terms of delta. Using this information in combination with the distance between the bids and offers from the theoretical value of the options, the user can make an even better informed decision on his trades.

Typically, the memory and the processor are part of a server, and the screen is part of a workstation which is in communication with the server.

In a second aspect, the invention proposes a computing device for displaying on a screen in communication therewith the orders for financial derivatives such as options, the options having the same exercise date, the orders being in the form of bids and offers of each of the options, wherein the computing device generates a chart for display on the screen, the chart having a horizontal axis representing options according to their strike price and a vertical axis representing the volatility, wherein each bid or offer is represented by a marker in the chart, a volatility line 201 in the chart indicates the volatility of the options, and each marker is placed at a distance from the volatility line 201 indicating the extent that the price of a bid or offer for an option represented by the marker differs from the theoretical value of the option.

Preferably, the markers representing the offers for each option are grouped into a top bar in the chart; and the markers representing the bids for the option are grouped into a bottom bar in the chart.

Preferably, the volatility line 201 is movable along the vertical axis from a first position to a second position, such that the theoretical values of the options are re-calculated according to the second position of the volatility line 201, and the markers are re-positioned to reflect the difference between the bids and offers from the re-calculated theoretical value.

Preferably, the screen is a touch screen, in communication with the computing device, and configured to permit the volatility line 201 to be adjustable along the vertical axis by the user interacting with the volatility line 201 on the touch screen. Preferably, the computing device in communication with the screen is configured to permit one or more points along the volatility line 201 to be fixed by the user such that the fixed points are not movable while the other points of the volatility line 201 are adjusted along the vertical axis.

Advantageously, the touch screen provides an interactive tool that allows a trader to immediately interact with the volatility line 201 of the options to help him visually set the thresholds at which he wants to trade the options. Alternatively, a normal computer screen in communication with the computing device, with a mouse pointer replacing the function of the touch sensing in the touch screen, can be used.

In a third aspect, the invention proposes a computer implemented method of evaluating financial derivatives such as options, comprising the steps of providing an updatable database of option data, including but not limited to order data, using the option data for generating on a display screen in communication with a computing device a chart, the chart having a horizontal axis representing options according to their strike price, and a vertical axis representing the volatility; the options having the same exercise date; representing on the chart each one of the bids and offers for each option by a marker, the markers of the options comprising top markers and bottom markers, wherein the top group of markers represent offers for the options; and the bottom group of markers represent bids for the options; generating and displaying via the computing device a volatility line 201 indicating the theoretical value of the options; positioning each marker from the volatility line 201 by a distance indicative of the extent to which the price of the bid or offer for an option represented by the marker differs from the theoretical value of the option.

The skilled man understands that the invention is also applicable to other kind of financial derivatives, such as warrants, futures, and so on.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 is a schematic diagram of the structure of an embodiment of the invention;

FIG. 2 is a chart provided in the embodiment of FIG. 1;

Table 1 shows an example of data for FIG. 2;

FIG. 3 is a flowchart indicating the steps taken in the embodiment of FIG. 1;

FIG. 3a illustrates how the chart of FIG. 2 is placed in a graphical user interface on a computer screen,

FIG. 4 is a variation of the chart of FIG. 2;

FIGS. 5 and 5a are further variations of the chart of FIG. 2;

FIG. 6 is a further variation of the chart of FIG. 2;

FIG. 6a is a further variation of the chart of FIG. 2;

FIG. 7 is a further variation of the chart of FIG. 2;

FIG. 8 is a further variation of the chart of FIG. 2;

FIG. 8a is a further variation of the chart of FIG. 2;

FIG. 9 is a further variation of the chart of FIG. 2;

FIG. 10 is a further variation of the chart of FIG. 2;

FIG. 11 is a further variation of the chart of FIG. 2;

FIG. 12 is a further variation of the chart of FIG. 2; and

FIG. 13 is a further variation of the chart of FIG. 2;

### DESCRIPTION OF AN EMBODIMENT

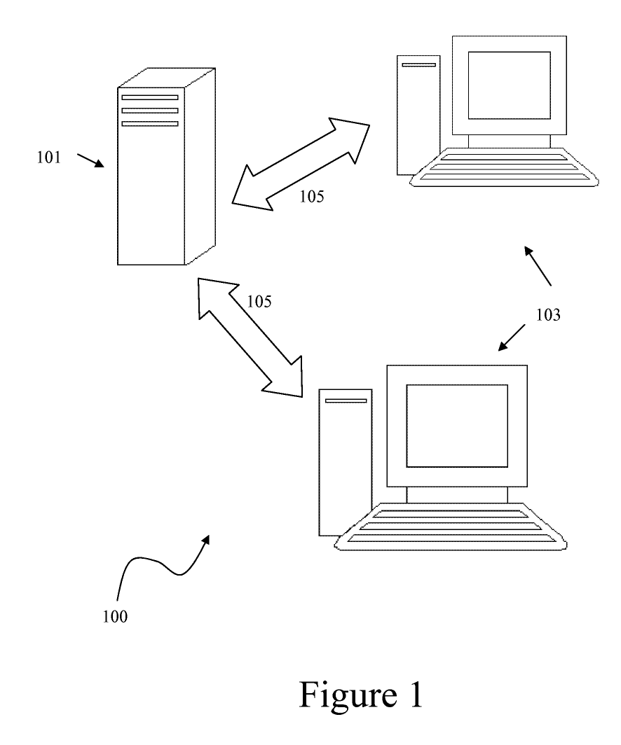

FIG. 1 shows a system 100 of the embodiment comprising a plurality of workstations 103 (only two are shown for sake of conciseness although many more may be included as part of the system) for accessing, at 105, a server 101 for receiving and storing option data including order data, transaction data, etc., preferably in real time and for processing the data to display price movements of an option. The workstations are able to access the server 101 by technical means such as wireless communication via a Wide Area Network such as the Internet or Local Area Network, a cable communication such as by telephone lines or fire optics.

The server 101 contains a memory to records bids and offers which option traders place via the workstations 103, as well as executes and records transactions of options. The records are preferably stored in a database in the server 101 memory. Updated records of transactions, bids and offers placed are sent to the plurality of workstations 103 immediately so that the workstations 103 show the traders the record updates in real-time. Accordingly, the traders will be able to decide on their subsequent order of bids and offers in reaction to the updated records, or even to withdraw any of their orders. Preferably, the workstations 103 compile information to trend the transactions, bids and offers and display the trend. In some other embodiments, the server 101 is also able to compile and process information to trend the transactions, bids and offers. Typically, the server 101 resides in the stock exchange authority's premises.

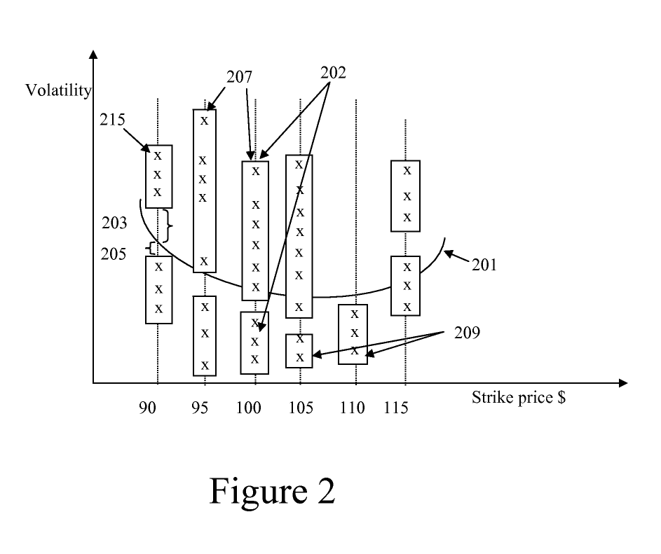

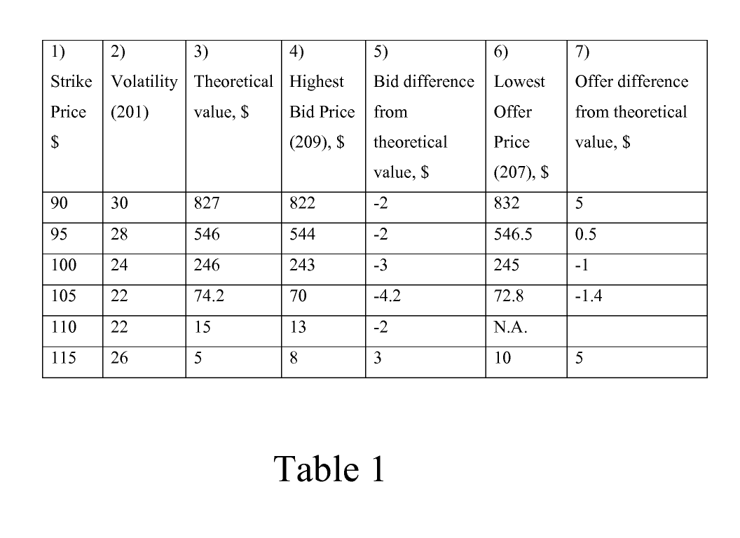

An example of a chart 200 shown in the screen of a workstation 103 is given as FIG. 2. Table 1 shows the volatility curve 201 of FIG. 2 in numbers, and gives an example of the theoretical values of the options, placed in the column next to the volatility. The bars 202 in FIG. 2 illustrate the difference in price between the bids and offers from the theoretical value represented by the volatility line in 201. The same difference is shown in numbers in Table 1. That is, the values in column 5) are represented in the chart 200 by the distance 205 between the top ends of the bid bars 209 or bid markers 251 to the volatility line 201, while the values in column 7) are represented in the chart 200 by the distance 203 between the bottom ends of the offer bars 207 or offer markers 251 to the volatility line 201.

In this example, the chart 200 represents only call options 202 of different strike price for the same underlier, all having the same exercise date. The axes of the chart 200 are not drawn to scale to simplify the illustration.

The horizontal axis in the chart 200 of FIG. 2 is a scale of option strike prices i.e. $90, $95, $100, $105, $110, with a graduation of $5.

The vertical axis of the chart 200 is a scale of volatility. Thus, the chart 200 shows a volatility line 201 indicating the volatility of the options. Preferably, all the options have the same expiry data and are of the same underlier. The volatility line 201 is usually a curve with upward pointing ends and is nicknamed in the finance industry a ‘volatility smile’. Accordingly, the volatility line 201 in the chart 200 gives a graphical indication of the volatility of each of the options represented in the chart 200.

There are several formulae for creating a volatility line 201, all stemming from different mathematical models. One example is the SABR (“Stochastic Alpha, Beta, Rho”) volatility model, which is a stochastic volatility model that captures the volatility smile in derivatives markets. Details for volatility smile models such as this can be found in many websites and textbooks and will be described here only briefly as the model itself is not the focus of the invention. SABR is a dynamic model where an underlying asset such as forward F, with parameter a as the volatility of F, are represented by stochastic state variables whose time evolution are described by two differential equations of

dFₜ=σₜFₜ^{β}dWₜ, (1)

dσₜ=ασₜdZₜ, (2)

where Wₜ and Zₜ are two correlated Wiener processes with correlation coefficient—1<p<1 and parameters β and α with the conditions 0≦β≦1 and α≧0.

There exist solutions to these equations which this description need not explore as the skilled man will understand the application of the volatility model to option pricing.

The volatility of an option can be calculated in a number of ways. For instance it can be calculated from a model such as the one above given a certain set of parameters to try to estimate the actual volatility of the option. This volatility value can be applied to a pricing model such as Black-Scholes to obtain a theoretical price value. Conversely, if one knows the price of an option and the other Black-Scholes parameters, then one can back-calculate the volatility, known as the implied volatility. That is, the price of the option “implies” that the option has certain volatility. Thus ‘volatility’ used in the description is a term that can be used to mean ‘estimated’ or ‘implied’ volatility, depending on the way the trader wishes to approach his valuations.

It suffices here to say that ‘volatility’ is a measure of the rate and magnitude of the change of prices of the underlier, as well as an asset in itself that is valued, traded, and is susceptible to increases and decreases in value from market forces. If volatility is high, the premium on the option, i.e. price of the option, will usually be high, and vice versa.

Based on the volatility of an option, along with other factors such as current value of the underlying, time to the option's exercise date, and strike price, the ‘theoretical value’ of an option can be calculated. Typically, a trader would want to buy an option below the theoretical value or sell an option above the theoretical value. Thus, knowing the theoretical value of an option is useful to a trader in making a decision to buy or sell an option.

Typically, the actual market value is never quite the same as the theoretical value. The difference is known as option mispricing.

Markers 215, indicated as crosses ‘x’ on the chart 200, represent the bids and offers raised for the options. The markers 215 are not placed on the chart 200 according to the vertical axis. Instead, the markers 215 are placed away from the volatility line 201 in such that the distance between each marker 215 and the volatility line 201 represents the deviation of the price of bid or offer from the theoretical value (theoretical price).

For purpose of illustration, each intersection of the volatility line 201 and the vertical lines extending from the horizontal axis in the chart 200 of FIG. 2 is deemed to be the point on the volatility line 201 representing the theoretical value of the option at the strike price indicated in the horizontal axis.

This means that the volatility line 201 is generated so as to provide the positions on the chart 200 to represent the options' theoretical values. The distance of each marker 215 from the volatility line 201 represents how far the bid or offer the marker 215 represents deviates, at 203, 205, from the theoretical value.

The specific distance from volatility line 201 representing a unit price difference between each bid or offer from the option's theoretical value may be factory set, and is not important as long as all the markers 215 in the same chart 200 consistently use the same distance to represent the same unit price, e.g. 10 pixels represents $1.

Thus, the visual representation of the processed data as displayed on the chart 200 provides the trader the possibility of telling at a glance the magnitude of the mispricing for each option from the theoretical value; the trader simply looks at the distance between each bids or offers from the volatility line 201. The trader can then decide if he wants to put up an offer or a bid to close a transaction or adjust pricing parameters.

It should be noted that the theoretical value of each option does not determine the position of the volatility line 201. The position of the volatility line 201 is simply selected to represent the theoretical value of each option. Table 1 shows that the actual theoretical value is not necessarily linearly proportional to the volatility, and cannot be represented by a similar curve.

The volatility line 201 is nevertheless related to theoretical value because the theoretical value is calculated from the volatility, along with other factors such as time to expiry and strike price of the option. Thus, if volatility changes, the theoretical value also changes.

More specifically, the theoretical value can be evaluated from well known option pricing methods such as the Black-Scholes option pricing model, where the volatility or ‘implied volatility’ is the main unknown attribute of an option. If the volatility of the option is changed by changing the standard deviation parameter, the theoretical value will change as well. The formula for this maybe found in many websites or textbooks and will be reproduced here only briefly as:

C=S N(d₁)−Xe^{-rT}N(d₂) (3)

where
C=price of the call option
S=price of the underlying stock
X=option exercise price
r=risk-free interest rate
T=current time until expiration
N( )=cumulative standard normal distribution
d₁=[ln(S/X)+(r+σ²/2)T]/σ^{1/2}
d₂=d₁σT^{1/2}
σ=standard deviation of underlying asset returns
and the value of a put (P) is:
P=Xe^{-rT}N(−d₂)−S N(−d₁)

FIG. 2 also shows that most of the markers 215 for each option are grouped into a pair of two bars 207, 209. This is illustrated as a top bar 207 and a bottom bar 209 for the option of $95. The top bar 207 groups the markers 215 representing offers for the option. The lower bar 209 groups the markers 215 representing bids for the option. In other words, the bars 202 graphically group the markers 215 according to offers and bids for the same option.

Each top bar 207 has a highest marker 215 and a lowest marker 215 each positioned at the respective two ends of the top bar 207. These markers 215 indicate the highest and the lowest of the offers for the option.

Similarly, each bottom bar 209 has a highest marker 215 and a lowest marker 215 at the respective two ends of the bottom bar 209. These markers 215 indicate the highest and the lowest bids for the same option.

FIG. 2 shows that the option at the strike price of $110 does not have any existing offer and, thus, the top bar 207 is missing.

FIG. 2 also shows that there are some markers 215 missing within the bars for the options at strike price of $95, $100, and $105. Missing markers 215 means that there is no bid or offer at that specific price difference from the theoretical value indicated using the volatility line 201.

While it is possible to show only markers 215 without grouping the markers 215 into bars, it is easier for the trader to tell which marker 215 is a bid marker 215 and which marker 215 is an offer marker 215 when the markers 215 are grouped into bars 202. Preferably, the markers 215 or the bars 202 are colour coded to indicate which markers 215 and bars 202 represent bids and which markers 215 and bars 202 represent offers (not illustrated).

The gap between the top bar 207 and bottom bar 209 of each option indicates the discrepancy between the lowest offer 207 and the highest bid 209. There is always a gap between the lowest offer 207 and the highest bid 209 because any match between bids and offers will result in an immediate transaction. Transacted bids and offers are removed from representation in the chart 200 at once.

In a variation of the embodiment where bars are not used, the same gap would be seen between the lowest offer marker 215 and the highest bid marker 215.

Accordingly, the chart 200 allows a trader looking at the chart 200 to be able to tell how close is a bid or offer for any option near the theoretical value of that option, based on the visible distance between the bars 202 or markers 215 and the volatility line 201. At the same time, the trader can tell at a glance what the implied volatilities of the options are, directly by observing the volatility line 201 relative to the markers 215. The graphical presentation of both the option volatility and price difference from the theoretical value gives the trader immediate information for evaluating the options. In contrast, if the trader tries to obtain the same information by looking at numerical values such as those given in Table 1, he will find it more difficult and time consuming to come to grasp with the volatility of each bid and offer, and the corresponding price difference from the theoretical value.

In practice, when the trader sees that orders on the bid price for an option has risen close enough to the volatility line 201, indicating the theoretical value for that option, or has extended above the theoretical value, the user can choose to place an offer to match the highest bid price. This immediately results in a transaction of the option. It should be noted that ‘close’ is a subjective opinion which depends on the trader himself.

Similarly, if the trader sees that orders on the offer price has dropped close enough to the theoretical value, or has extended below the theoretical value for that option, the user can choose to place a bid to match the offer.

Although not mentioned, the skilled man understands that the amount or volume of options to be transacted is specified via a suitable interface on the workstation, as is known in art. For example, a textbox can be used in which the trader enters the volume he wants to transact, and volume for individual orders can be shown as information next to the order markers 215 (not shown).

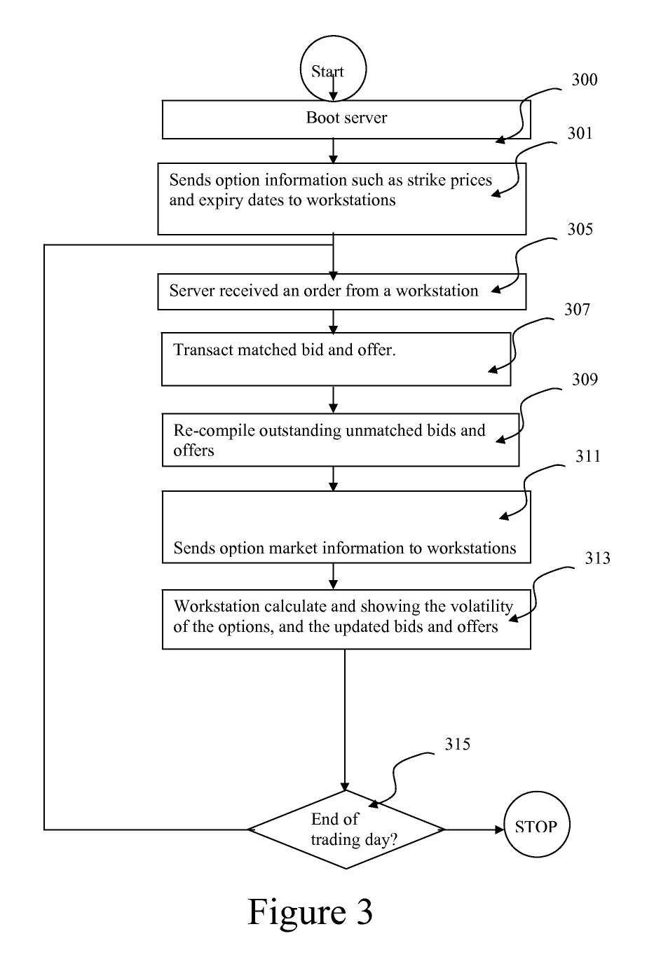

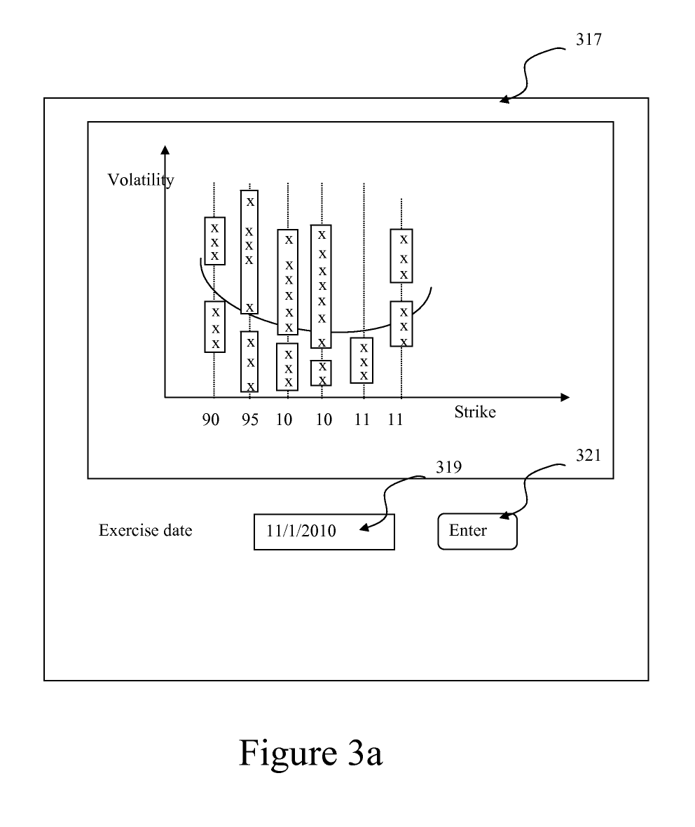

FIG. 3 is a flowchart showing one example of how the system 100 operates. When the system 100 is booted up before trading starts, at step 300, the server 101 organises data on existing options in the market into sets of options according to their exercise dates. Specific information on the options such as issuers, exercise dates, strike price, issuers are already pre-entered into the system 100 and are possibly obtained from the stock exchange authorities.

When a workstation 103 is logged into the server 101, typically by a trader working at the workstation 103, the server 101 sends data on the option market to the workstation, at step 301. This includes the option price, any existing order or bids and offers already placed by traders.

At the same time, when different traders place their orders from their different workstations 103, their bids and offers are submitted via the workstations 103 to the server 101, at step 305, which immediately executes matched offers and bids, at steps 307, and sends an update of all the bids and offers which remains unmatched, at step 309, to the workstations 103, at step 311. The network allows the workstation 103 to re-generate the chart 200 in real-time. The matched bids and offers which are transacted are cancelled from display in the chart 200.

When the chart 200 is generated in the workstation 103, the volatility and the theoretical value of each option are also calculated, at step 313, which are then displayed in a chart 200 as shown in FIG. 2. Furthermore, workstation 103 is responsive to the trader's interaction to display different charts 200 of options of different exercise dates.

The steps are repeated as orders from workstations are raised and recorded in the server 101 until the system 100 detects the end of the trading day, at step 315.

FIG. 3a is a simplified diagram of a graphical user interface (GUI) in a computer screen showing the chart 200 of FIG. 2, and providing a text box 319 in which an option exercise date can be input and submitted via an ‘Enter’ button 321, such that the chart 200 will be re-generated for options of the entered exercise date. Although not shown, other text boxes and buttons may be provided for entering transaction volume, trader identity, parameters for calculating volatility by a different formula, selecting another underlier, selecting options of a specific issuer and so on.

It is possible that instead of the workstation 103, the server 101 calculates the volatility of the options, at step 313, and sends the volatility data to the workstations 103 to be displayed as a volatility line 201. However, using a local workstation 103 for calculating the volatility allows an advantage of each trader having the capability for modifying the volatility line 201 in the chart 200 shown in his own workstation 103.

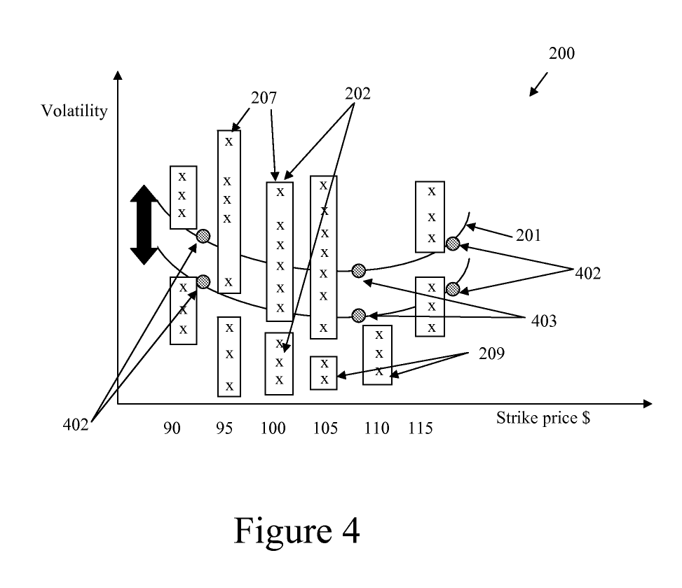

FIG. 4 shows a variation of the embodiment in which the chart 200 is interactive, where the user is able to move the volatility line 201. For example, a mouse pointer is able to click onto interaction points 403 on the volatility line 201 and to move the volatility line 201 along the vertical axis. The movement of the volatility line 201 is illustrated by the double-headed arrow at the left side of the chart 200 shown in FIG. 4.

The positions of the interaction points 403, 402 on the volatility line 201 are chosen to facilitate convenient interaction. Preferably, the interaction points are generated to reflect parameters of the volatility smile model itself, such that point 403 at the centre of the volatility line 201 reflects a parameter change that moves the entire line, while the interaction point 402 at the left end of the volatility line 201 modifies a parameter that adjust the left part of the volatility line 201 and the interaction point 402 at the right end of the volatility line 201 modifies a parameter that adjust the right part of the volatility line 201.

Moving the volatility line 201 helps the trader to visually re-establish his personal tolerance for price of the bids and offers. That is, moving the volatility line 201 upwards along the vertical axis means more low ends of offer bars 207 can now easily penetrate through the volatility line 201. This means that the trader is changing his expectations on the value of options and is willing to pay more for the options.

If the volatility line 201 is moved, the volatility of the option changes correspondingly. Thus, factors contributing to the calculation of the volatility line 201 also changes. The new factors, based on the new position of the volatility line 201, can be back-calculated from whichever volatility formula is used. The changes in these factors as well as resulting changes of values or of an outstanding portfolio can be displayed in an area such as a message box 501. The display can include
change in theoretical value of each option
change in volatility of each option
change in profit and loss from an outstanding position that one or more linked trading books from the proposed move.

This provides immediate information on what happens if the volatility line 201 is moved.

It should be noted that the theoretical values of the options will change as the volatility changes because the theoretical values are re-calculated in accordance with the change in volatility. As a result, the markers 215 and the bars 202 are repositioned when the volatility line 201 is moved, to reflect the change in the re-calculated theoretical values and also to move in tandem with the new position of the volatility line 201

Alternatively, volatility line 201 adjustment can also be done by entering values into the parameters of the formula (not illustrated), instead of adjusting the volatility line 201 graphically. One example of such a value is the “skewness” parameter of a volatility smile model. Skewness can also be thought of as the “smiley-ness” of the curve, and is occasionally colloquially referred to as such in the industry. Thus moving the line to make it more curved would increase the skewness parameter, and similarly, manually increasing the parameter itself would result in the displayed curve being more curved. Such factors are known to the skilled man and need not be explained in detail here.

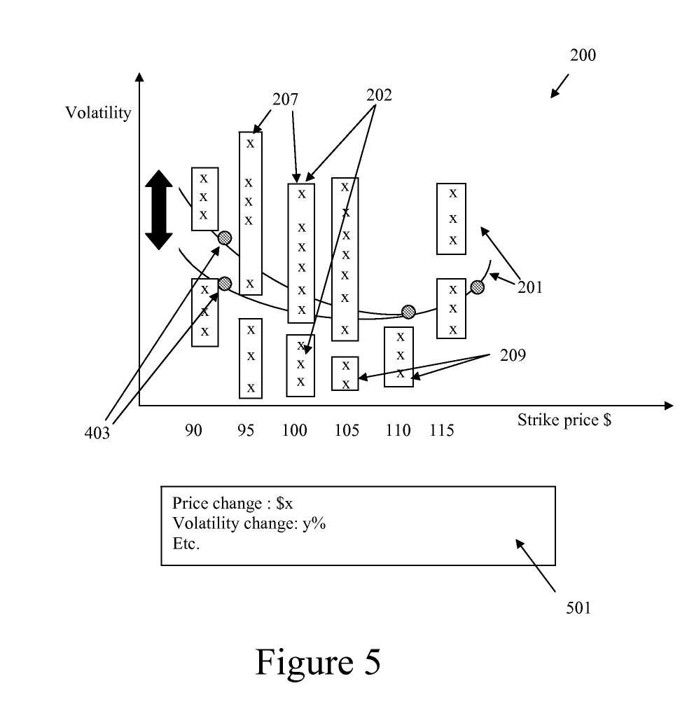

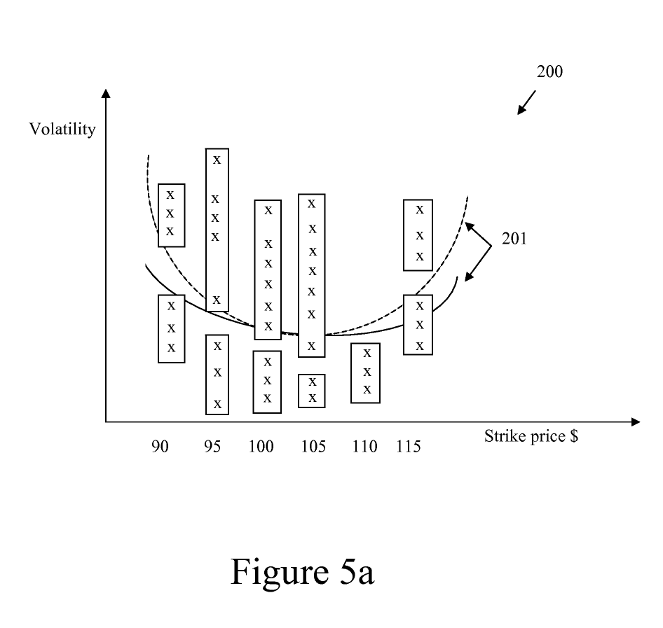

Preferably, one or more of the interaction points can be “pinned” and be made un-movable before moving other parts of the line, allowing for a change in one or more parameters of the volatility model based on the modified graphical representation. This is illustrated in FIG. 5, where the right most interaction point is fixed and the left most point is moved up, such that the skew of the volatility line 201 is increased for the lower strike options only, allowing a change in volatility line 201 for the options at strike prices $90 to $105 and not for those at $110 and $115.

FIG. 5a shows a variation of the embodiment in which the curvature of the volatility line 201 is adjusted by the trader instead of simply being moved along the vertical axis. This provides the trader flexibility to apply information that is generated externally (such as fundamental or historical analysis) to be represented on the curve as well as physically moving it with the assistance of market orders.

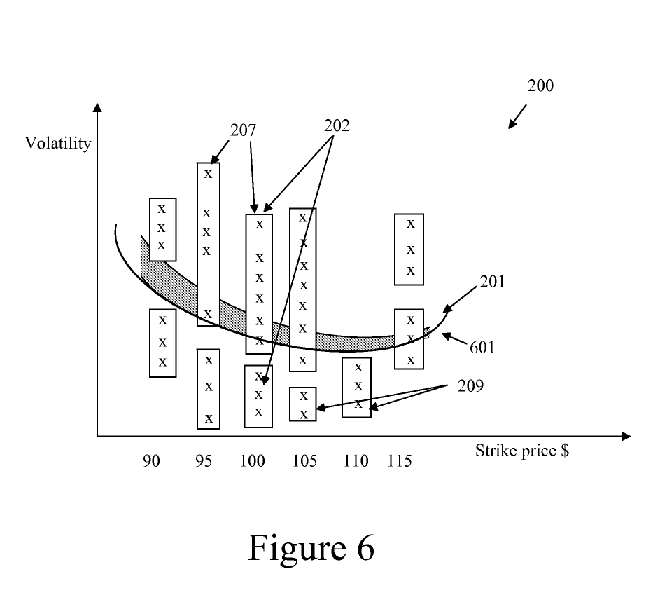

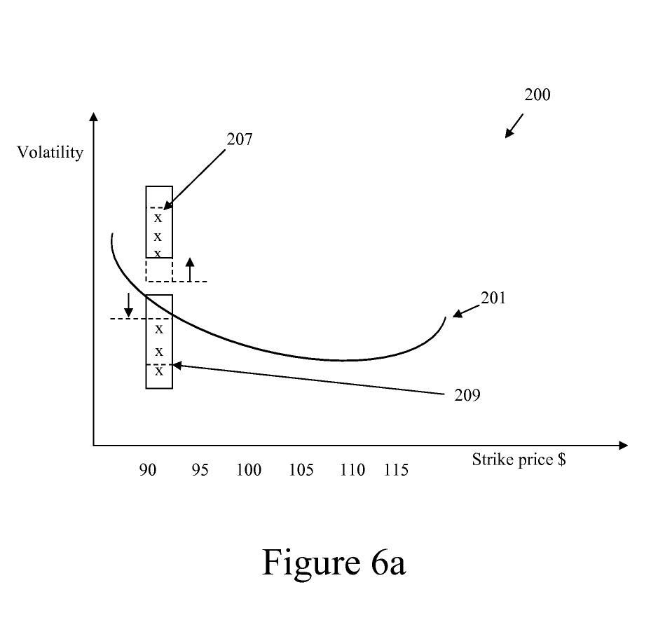

FIG. 6 shows yet another variation of the chart 200, where the volatility line 601 has a thickness which indicates the cost of a transaction which could include fees other than the price indicated by the bids and offers, such as costs to cross hedging trades (such as delta hedging, cost of trading the roll etc). In the earlier embodiment, if the lowest offer is priced at $x, and $x is $1 above the theoretical value, the lower end of the bar representing this offer would be positioned at a distance y from the volatility line 201 representing the $1 difference. If, however, for every unit volume of option traded there is a fee of $0.5 to be paid to the stock exchange authorities, then the volatility line 201 has a thickness which indicates $0.5. This reduces the distance y from the volatility line 201 by half. By representing this $0.5 using the thickness of the volatility line 201, the trader can tell at a glance that the actual difference in the offer price from the volatility line 201, while certainly $1 in transaction between the seller of the option and him, is only $0.5 in practice due to the amount payable to the stock exchange authorities. In other words, the extent to which the volatility line 201 is thickened is calculated by how much the transacted price differs from the theoretical value for both offers and bids.

Other than fees payable to the stock exchange authorities, the skilled man understands that different types of fees can also be reflected in the thickness of the line. Preferably, different colours/shades/patters (not illustrated) along the thickness of the line represents different types of fees/costs, or anything else that reduces the profit. For the purpose of illustration, FIG. 6 shows that the option at strike price of $115 has less transaction costs than those of other strike prices. In this way, the traders are able to tell at a glance whether the bids and offers are worthwhile transactions given the theoretical value as well as the other fees incurable in transacting.

In a variation of the embodiment, instead of thickening the volatility line 201 to reflect costs and fees payable on transaction, the positions of the markers 215 and the bars 202 are adjusted to reflect these costs and fees instead. For example, if there is a bid bar 209 the upper end of which is near the volatility line 201 by a distance representing $1, and there is a fee of $0.5 in trading the bid, instead of having a thicker volatility line 201, the bid bar 209 and the attached markers 215 are moved lower relative to the volatility line 201 by a the distance equivalent to $0.5. This is illustrated in the simplified chart 200 of FIG. 6 shown as FIG. 6a, where both the top and bottom bars 202 are moved in the chart 200 to reflect the transaction fees. Typically, bid prices are adjusted lower, and offer prices are adjusted higher.

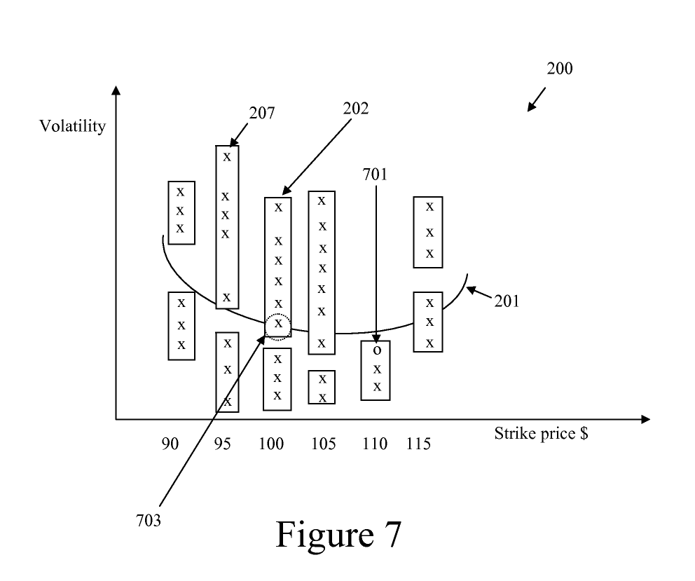

FIG. 7 shows yet a further variation of the embodiment, wherein the chart 200 provides interactive means for the user to place conditional orders, i.e. one or more bids or offers that are to be maintained as long as a target order 703 exists. If the target order 703 no longer exists such as if the target order was matched, transacted and cancelled, the conditional order 701 will be retracted automatically. FIG. 7 shows a conditional order 701 for a bid, marked by an ‘o’ in the chart 200 instead of an ‘x’, which is set as visual offset against a particular existing order 703 in the market, marked as an encircled ‘x. If the target order 703 re-appears after it was cancelled or matched, the conditional offer is placed back automatically. The purpose of this facility allows for automation for the trader such that if the trader's order 701 is traded, the conditional order 703 will be traded automatically also.

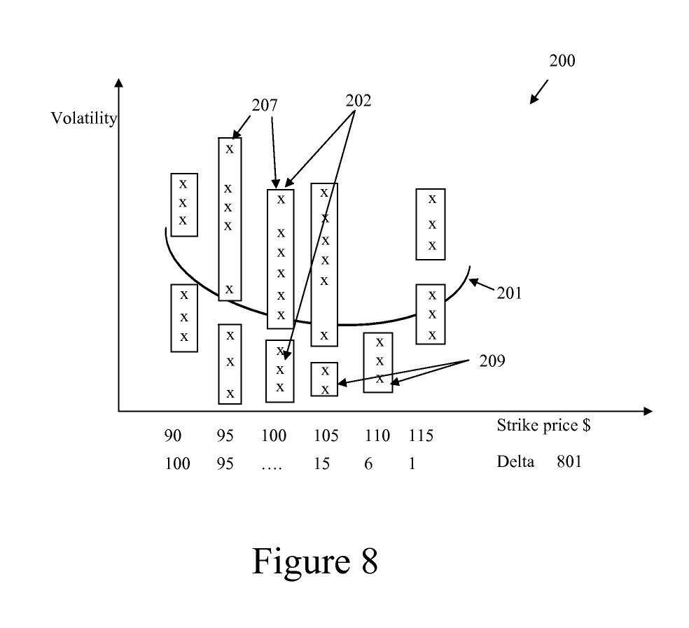

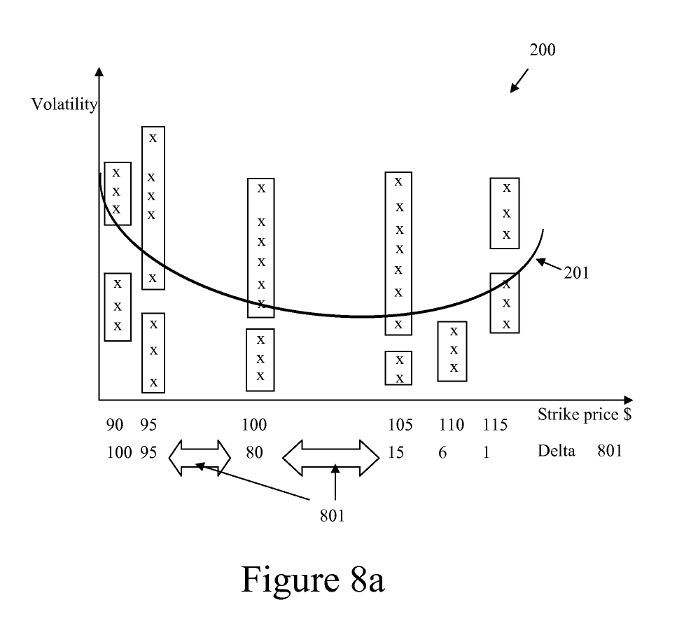

FIG. 8 shows yet a further variation of the embodiment, where the horizontal axis shows the delta value 801 of each of the options. The delta of each option is simply a value indicating the probability that the underlier will be at the strike price by the exercise date. One such formula for delta calculation is simply a sub calculation from the Black-Scholes formula outlined above in Equation (3) where the delta of a call is N(d₁) and the delta for the put is N(d₁)−1.

In FIG. 8, the chart 200 shows that for the option having the strike price of $90 the delta is 100. This means that there is a 100 percent chance that the price of the underlier will reach the strike price of $90 or above at the exercise date of the option. As the chart 200 indicates only call options, the delta indicates that the underlying is going to be equal or above the $90 at the exercise date of the option. Similarly, the option at the strike price of $95 is shown to have a delta of 95. This means that there is a 95% chance that the price of the underlier will be at or above the strike price of $95 at the exercise date of the option. In a similar chart 200 for put options (not shown), a 95% call delta would be equivalent to a 5% put delta by induction.

The chart 200 of FIG. 8 shows how a trader is able to have an indication of the difference between the option bid or offer prices and the theoretical value, the volatility of each option and also the delta of each option.

FIG. 8a shows an alternative chart 200 wherein the bars are spaced on the horizontal axis at positions relative to the delta of each option, illustrated by the arrows at the bottom of the horizontal axis. This provides a graphical representation of how similar in delta is one option to another option. The advantage of positioning the bars in such a way is that the trader can visually tell at a glance how the different options fare in the delta value once against another.

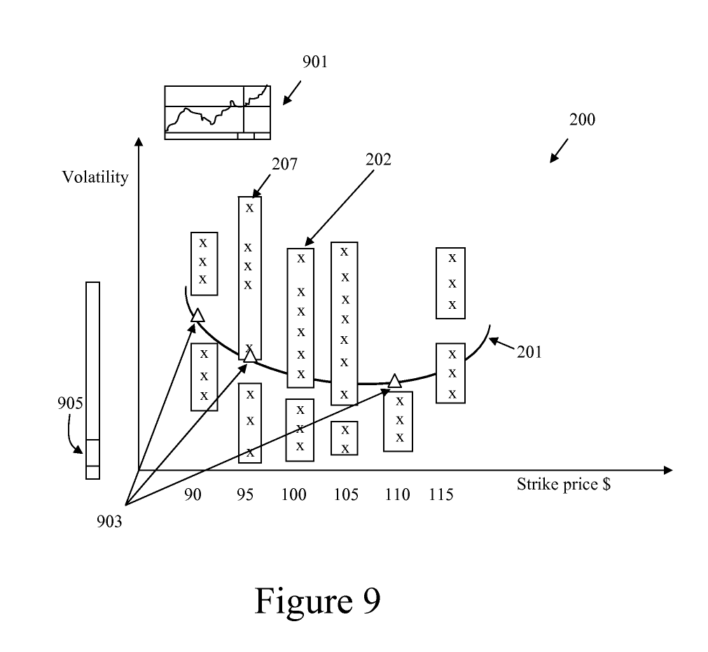

FIG. 9 shows a further variation of the embodiment, wherein a slide bar 905 is provided for the trader to navigate through the historical records of the underlier, which is shown as an attached graphical presentation 901 on the chart 200. The slide bar 905 can be dragged along a timeline that moves the position of historical chart 200 shown in the graphical presentation 901.

Furthermore, FIG. 9 also shows the transacted price of the different options, indicated by triangular markers 903, at the historical time selected using the slide bar 905. Thus, at different points of time in the history of the underlier selected by the slide bar 903, relevant triangular makers will appear and disappear on chart 200 showing the transaction price of the options. This helps the trader to review the historical price movements of the options.

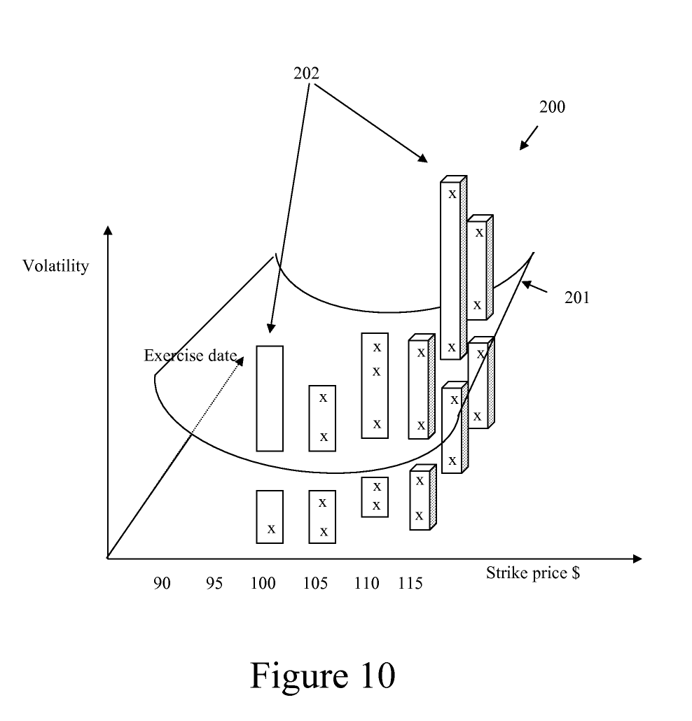

FIG. 10 shows a further variation of the embodiment, which is a three dimensional chart 200 wherein the depth of the chart 200 shows the theoretical values of the options at different exercise dates. The bars 202 are super-imposed on the three-dimensional chart 200, in the same way as discussed for the earlier embodiments. Only a few bars 202 are shown in

FIG. 10 for simplicity of illustration. The skilled man knows that different methods are possible to make the illustration clear and comprehensible, such as by using different colour schemes for options of different exercise dates, selective viewing of different bars by clicking on any one of them to make it disappear, to remove them from blocking any other bars from view. These are known technologies which need not be discussed here for the purpose of the embodiment. Accordingly, an embodiment such as that shown in FIG. 10 is able to arrange different sets of options of different exercise dates along the Exercise Date axis, i.e. the z-axis. In this way, the user is able to visually compare the bids and orders for options of the same strike price but different exercise dates.

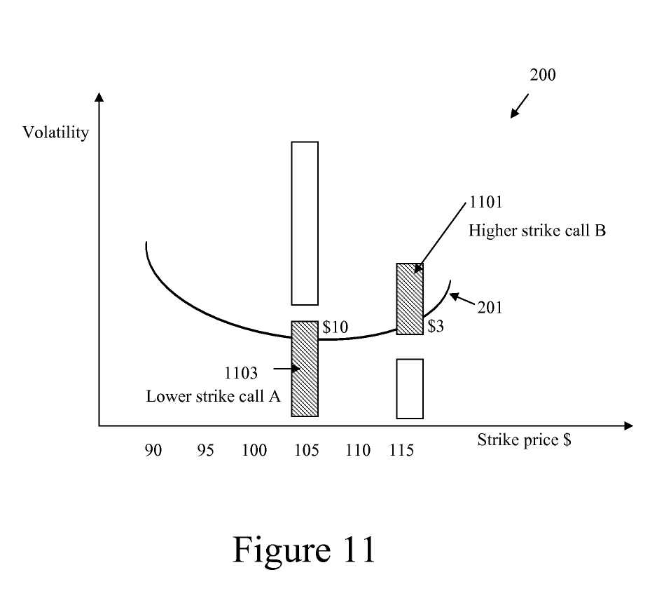

FIG. 11 shows how the chart 200 is applicable to buy or sell ‘strategies’. A ‘strategy’ is a combination of products, such as a pair of two call options known as a ‘call spread’. The call spread shown in FIG. 11 is that of a call option (A) 1103 with a lower strike price and having a theoretical value of $10, and another call option (B) 1101 with a higher strike price and a theoretical value of $3. According to the scale of the horizontal axis of chart, the option with the lower strike price is placed to the left of the chart 200 and the option with the higher strike price is placed to the right of the chart.

If someone buys call option (A) 1103 and sells call option (B) 1101 at the same time, the theoretical difference would be $7, i.e. $10−$3. Thus, if the trader places an order for the strategy at $6, meaning he buys one volume of call option (A) 1103 and sells one volume of call option (B) 1101 at the same time, he wishes to buy the more expensive option (A) 1103 at price which is offset by selling the cheaper option (B) 1101. This means he wishes to buy the strategy at a price which is $6−$7=−$1, i.e. a dollar cheaper than the theoretical value.

The difference between theoretical value of option (A) 1103 and the theoretical value of option (B) 1101 can be seen at a glance from the distances between the bars 1101 and 1103, and the volatility line 201. As in the other embodiments, the volatility line 201 also sets the position in the chart 200 representing the theoretical value of the options, whatever the price is. Thus, if we take the example where the theoretical value of option (A) and option (B) are $10 and $7 respectively, and the bid for the whole strategy is $8 the distance between the bars for the strategy (bid for A and offer for B) and the theoretical value line would have a combined distance from the volatility line 201 representing the value of $1 more than theoretical value. This can be represented by option (A) having a bid $0.5 higher than theoretical value, and option (B) having an offer $0.5 lower than theoretical value.

As a further example, if the trader sells the strategy at $11, then he would have bought option (B) 1101 and sold option (A) at a price which has made a gain of $11−$7=$4 above the theoretical value.

By allowing the trader to graphically appreciate the mispricings of strategies at a glance, the trader is able to use the chart 200 of FIG. 11 to make quick decisions on pricing and trading strategies. The skilled man would know that the combination of different options as a strategy is up to the trader or his broker. Furthermore, the skilled man would know how the calculations apply for strategies involving other products such as puts.

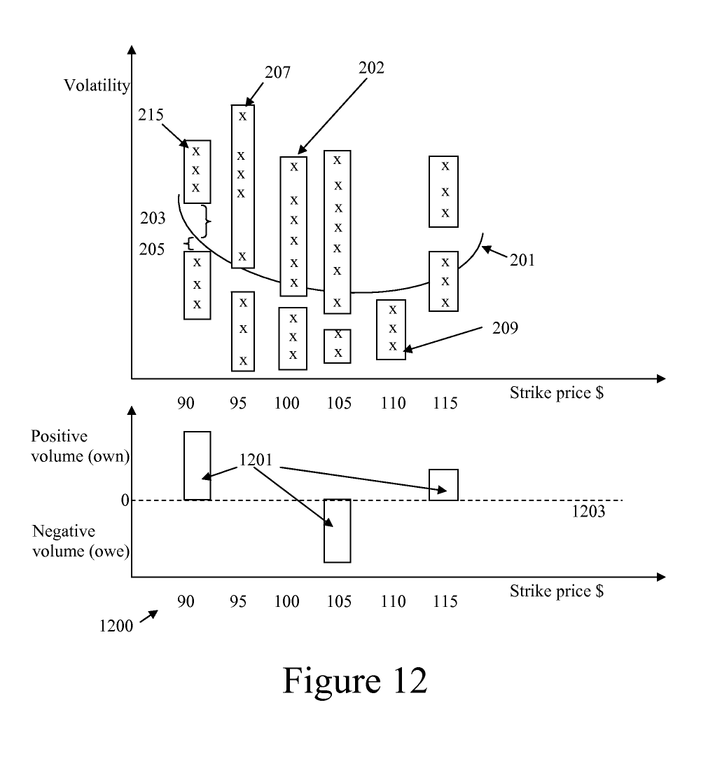

FIG. 12 shows yet another variation to the embodiment, which provides for further attributes of either information regarding the options themselves (such as a graph of theta, gamma etc) or the charting of the ‘positions’ held by the trader relative to the strikes. The latter example enables the user to tell at a glance whether he is long (owning more contracts than he owes) or short (owing more contracts than he owns) position, such as a certain strike or a certain parameter in the volatility model, and can react accordingly. This can be in the form of a ‘volume bar chart’ 1200 underneath the volatility chart 200. The zero line 1230 indicates zero volume and the bars extending upwards of the zero line shows the trader he owns specific volumes of the options at strike price $90 and $115 respectively, and the bar extending below the zero line shows the trader that he owes specific volumes of an option of the strike price 105. Thus, the positions of the bars in the volume bar chart 1200 correspond to the strike price of each option in the volatility chart 200, or to the movable points of the volatility line 201 in the case of being long or short parameters.

Alternatively, instead of having a separate volume bar chart 1200, the volatility line 201 is set as the zero line 1203, and thus any bars above the volatility line 201 is a long position, anything below the volatility line 201 is a short position, such that the distance from the volatility line 201 that reflects the volume of the options (this is not illustrated). In an alternative arrangement, the volume bar chart 1200 is superimposed on top of the volatility line 201 itself (not illustrated).

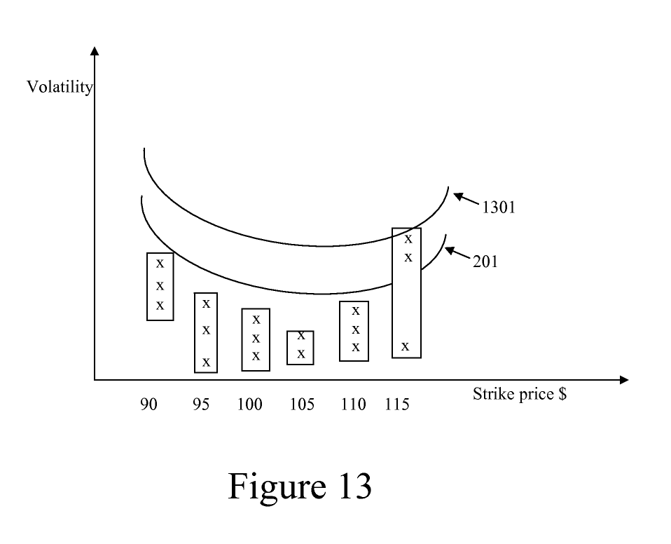

FIG. 13 illustrates a variation of the embodiment in which the trader can set a transaction threshold line 1301 for automating a particular action. One example would be selling a pre-determined volume of option to a bidder if any of the bid prices reaches the transaction threshold line 1301. Thus, a volume of the option at strike price 115 will be sold automatically. Another example would be placing multiple offer orders at levels above the transaction threshold line 1301 for each strike the threshold line applies to. Typically the transaction threshold line 1301 is higher than the volatility line 201 for selling a bid order as a trader will want to sell an order above the theoretical value. Although not illustrated, the converse is true for buying an offer but transaction threshold line 1301 is set below the volatility line 201.

Accordingly, the embodiments described comprise a computer based system 100 suitable for displaying orders for options comprising a memory for storing data related to orders for each option in a plurality of options for an underlying asset and other option data; a processor using the data for calculating a theoretical value and the volatility of each of the plurality of options; a screen for displaying the orders for the options, the orders being in the form of bids and offers of each of the options, the options having the same exercise date; the processor using the data for generating an output to the screen for displaying a chart 200 having a horizontal axis representing options according to their strike price, and a vertical axis representing the volatility; each one of the bids and offers being represented by a marker 215, the processor calculating a volatility for each option for display on the chart 200 as a volatility line 201 indicating the calculated volatility of the options; wherein the distance between each marker 215 from the volatility line 201 indicates the extent that the price of the bid or offer for an option represented by the marker 215 differs from the theoretical value of the option.

Furthermore, the embodiment includes a computing device in communication with a screen for displaying the orders for options, the options having the same exercise date; the orders being in the form of bids and offers of each of the options; wherein the computing device is capable of generating a chart 200 for display on the screen; the chart 200 having a horizontal axis representing options according to their strike price and a vertical axis representing the volatility; wherein each bid or offer is represented by a marker 215 in the chart 200; a volatility line 201 in the chart 200 indicates the volatility of the options; and each marker 215 is placed at a distance from the volatility line 201 indicating the extent that the price of a bid or offer for an option represented by the marker 215 differs from the theoretical value of the option.

Furthermore, the embodiment includes a computer implemented method of evaluating options, comprising the steps of providing an updatable database of option order data, using the option order data for generating on a display screen of a computer a chart 200, the chart 200 having a horizontal axis representing options according to their strike price, and a vertical axis representing the volatility; the options having the same exercise date; representing in the chart 200 each one of the bids and offers for each option by a marker 215, the markers 215 of the options comprising top markers 215 and bottom markers 215, wherein the top group of markers 215 representing offers for the options; and the bottom group of markers 215 representing bids for the options; computer generating and displaying a volatility line 201 indicating the theoretical value of the options; positioning each marker 215 from the volatility line 201 by a distance indicative of the extent to which the price of the bid or offer for an option represented by the marker 215 differs from the theoretical value of the option.

The invention may also be embodied as a computer readable medium having computer executable instructions stored thereon, which when executed by a processor cause the processor to generate and display the chart as identified above.

While there has been described in the foregoing description preferred embodiments of the present invention, it will be understood by those skilled in the technology concerned that many variations or modifications in details of design, construction or operation may be made without departing from the scope of the present invention as claimed.

For example, the skilled man would know that the examples and varying features of the given embodiments are not mutually exclusive and may all be embodied within one embodiment.

Furthermore, while bars are described, the skilled man understands that the markers 215 can be in the chart 200 without being grouped into bars. If some differentiation is required between markers 215 representing offers and makers representing bids, the markers 215 can be colour coded to show their bid or offer markers 215.

Furthermore, although the chart 200 displayed in the screen shows bars 202 indicating the offers and bids of the options, the bars 202 may be omitted in some embodiments wherein only markers 215 are used to identify the bids and offers. Although only crosses, i.e. ‘x’ and triangular marks are shown as markers 215 in the described embodiments, other types of markers 215 are possible. Furthermore, the markers 215 can be colour coded wherein the colour indicates volume, price and counter party and so on.

Furthermore, although the embodiments are described with reference to options, the skilled man understands that other embodiments can be used with other kind of financial derivatives, such as warrants, futures, and so on.

The skilled man will know that the ‘volatility’ in the embodiments may be the ‘implied volatility’, the ‘historical volatility’ or ‘estimated volatility’, depending on the approach the embodiments take in the valuation, and the difference between these volatility types depends on the formula used by the skilled man. For example the volatility line will represent implied volatility for a user wishing to “fit” the volatility line between the bid and offer prices. In another example a user may wish to estimate volatility by using a mathematical model with predefined parameters, and thus the volatility line will represent the estimated volatility. These terminologies and formulae are well understood and need to be explained in detail here.

It is understood that the programs, processes, methods and apparatus described herein are not related or limited to any particular type of computer or network apparatus (hardware or software), unless indicated otherwise. Various types of general purpose or specialized computer apparatus, processors or computing devices may be used with or perform operations in accordance with the various embodiments described herein.

1. A computer based system suitable for displaying orders for financial derivatives comprising:
a memory for receiving and storing data related to order for each financial derivative in a plurality of financial derivatives for an underlying asset;
a processor for using the data for calculating a theoretical value and the volatility of each of the plurality of financial derivatives;
a screen in communication with the processor for displaying the orders for the financial derivatives,
the orders being in the form of bids and offers for each of the financial derivatives,
the financial derivatives having the same exercise date;
the processor generating a chart for display on the screen having a strike price axis representing financial derivatives according to their strike price, and a volatility axis representing volatility;
each one of the bids and offers being represented by a marker in the chart,
the processor generating and displaying on the chart a volatility line indicating the calculated volatility of the financial derivatives;
wherein
the markers are placed such that the distance between each marker from the volatility line indicates the extent that the price of the bid or offer for a financial derivative represented by the marker differs from the theoretical value of the financial derivative.

2. The system suitable for displaying orders for financial derivatives as claimed in claim 1, wherein
the volatility line is user movable along the volatility axis from a first position to a second position;
such that
the theoretical values of the financial derivatives are re-calculated according to the second position of the volatility line; and
the markers are re-positioned to reflect the difference between the bids and offers from the re-calculated theoretical value.

3. The system suitable for displaying orders for financial derivatives as claimed in claim 2, wherein
one or more points along the volatility line can be fixed by a user of the system such that the fixed points are held in the fixed position when the other points of the volatility line are adjusted along the volatility axis.

4. The system suitable for displaying orders for financial derivatives as claimed in claim 1, wherein
the processor calculates and displays a thickness of the volatility line which corresponds to a cost of transaction for each of the financial derivatives.

5. The system suitable for displaying orders for financial derivatives as claimed in claim 1, wherein
the processor directs the markers representing the offers for each financial derivative to be grouped into a top bar in the chart; and
the markers representing the bids for the financial derivative to be grouped into a bottom bar in the chart.

6. The system suitable for displaying orders for financial derivatives as claimed in claim 1, wherein
for each financial derivative, the processor generates a delta value which is displayed in the chart.

7. The system suitable for displaying orders for financial derivatives as claimed in claim 6, wherein
the markers representing financial derivatives of different strike prices are spaced apart from each other by the processor along the strike price axis in the chart in proportion to each delta thereof.

8. The system suitable for displaying orders for financial derivatives as claimed in claim 1, wherein
the memory and the processor are part of a server; and
the screen is part of a workstation which is in communication with the server.

9. A computing device in communication with a screen device for displaying orders for financial derivatives,
the financial derivatives having the same exercise date;
the orders being in the form of bids and offers for each of the financial derivatives; wherein
the screen via the computing device is capable of displaying a chart;
the chart generated by the computing device having a strike price axis representing financial derivatives according to their strike price and a volatility axis representing volatility; wherein
each bid or offer is represented by a marker in the chart;
a volatility line generated by the computing device for display in the chart indicates the volatility of the financial derivatives; and
each marker, via the computing device, is placed at a distance from the volatility line indicating the extent that the price of a bid or offer for a financial derivative represented by the marker differs from the theoretical value of the financial derivative.

10. The computing device in communication with the screen for displaying the orders for the financial derivatives as claimed in claim 9, wherein
the markers representing the offers for each financial derivative are grouped via the computing device into a top bar in the chart; and the markers representing the bids for the financial derivative are grouped via the computing device into a bottom bar in the chart.

11. The computing device in communication with the screen for displaying the orders for the financial derivatives as claimed in claim 10, wherein
the volatility line is user movable along the volatility axis from a first position to a second position;
such that
the theoretical values of the financial derivatives are re-calculated via the computing device according to the second position of the volatility line; and
the markers are re-positioned via the computing device to reflect the difference between the bids and offers from the re-calculated theoretical value.

12. The computing device in communication with the screen for displaying the orders for the financial derivatives as claimed in claim 11, wherein
one or more points along the volatility line can be fixed by the user such that the fixed points are not movable when the other points of the volatility line are adjusted via the computing device along the volatility axis.

13. The computing device in communication with the screen for displaying the orders for the financial derivatives as claimed in claim 11, wherein
the screen is a touch screen, and the volatility line is adjustable by the user along the volatility axis using the touch screen.

14. The computing device in communication with the screen for displaying the order for financial derivatives in claim 11 wherein
the computing device calculates and displays a thickness of the volatility line which corresponds to a cost of transaction for each of the financial derivatives.

15. A computer implemented method of evaluating financial derivatives, comprising the steps of
providing on a screen in communication with a computer a computer generated chart
the chart having a strike price axis representing financial derivatives according to their strike price, and a volatility axis representing the volatility;
the financial derivatives having the same exercise date;
representing in the chart each one of the bids and offers for each financial derivative by a marker,
organizing the markers of the financial derivatives as a top group of markers and a bottom group of markers, wherein
the top group of markers represent offers for the financial derivatives; and
the bottom group of markers represent bids for the financial derivatives;
providing a computer generated volatility line indicating the theoretical value of the financial derivatives;
positioning each marker from the volatility line by a distance indicative of the extent to which the price of the bid or offer for a financial derivative represented by the marker differs from the theoretical value of the financial derivative.

16. The computer implemented method of evaluating financial derivatives as claimed in claim 15, further comprising the step of
moving the volatility line along the volatility axis from a first position to a second position;
such that
the theoretical values of the financial derivatives are re-calculated via computer according to the second position of the volatility line; and
the markers are re-positioned to reflect the difference between the bids and offers from the re-calculated theoretical value.

17. The computer implemented method of evaluating financial derivatives as claimed in claim 15, further comprising the step of
for each financial derivative, generating a delta value which is displayed in the chart.

18. The computer implemented method for evaluating financial derivatives as claimed in claim 17, further comprising the step of
spacing apart the markers representing financial derivatives of different strike prices from each other along the strike price axis in the chart in proportion to each delta thereof.

19. The computer implemented method for evaluating financial derivatives as claimed in claim 17, further comprising the step of
calculating and displaying a thickness of the volatility line which corresponds to a cost of transaction for each of the financial derivatives.
